(19) United States
(12) Patent Application Publication
(10) Pub. No.: US 2007/0103315 A1
(43) Pub. Date: May 10, 2007

(54) Flexible animal tag, printing system, and methods

(76) Inventor: Randolph K. Geissler, Hudson, WI (US)

Correspondence Address: MERCHANT & GOULD PC, P.O. BOX 2903, MINNEAPOLIS, MN, 55402-0903, US

(21) Appl. No.: 11/592,724

(22) Filed: Nov. 2, 2006

Related U.S. Application Data
(60) Provisional application No. 60/732,865, filed on Nov. 2, 2005.

(51) Int. Cl. G08B 13/14; G08B 23/00

(52) U.S. Cl. 340/572.8; 340/573.1

(57) ABSTRACT

The present invention relates to a flexible and/or implantable radio frequency identification system, such as a flexible and/or implantable radio frequency identification system for tracking animals. The present invention relates to a printing system for animal tags, and methods employing the system. The system includes a printer and processor. The processor is configured to direct printing by the inkjet printer on an animal tag of a government identifier and producer specified indicia upon demand by the producer. The printer is configured for durable printing on an animal tag.

### CROSS REFERENCE TO RELATED APPLICATION

This application claims the benefit of U.S. Provisional Patent Application Ser. No. 60/732,865, filed Nov. 2, 2005, which is hereby incorporated by reference.

### FIELD OF THE INVENTION

The present invention relates to a flexible and/or implantable radio frequency identification system, such as a flexible and/or implantable radio frequency identification system for tracking animals.

### BACKGROUND OF THE INVENTION

Radio frequency identification (RFID) systems are well known. RFID systems include either active systems wherein the transponder includes its own power source or passive systems wherein the transponder receives its power from a base station. Since passive RFID systems do not require their own power source they are generally smaller, lighter, and cheaper to manufacture than active RFID systems. Consequently, passive systems are more commonly employed in RFID systems for the purpose of tracking as compared to active systems.

Passive RFID systems are generally either inductively coupled RFID systems or capacitively coupled RFID systems. The present disclosure is applicable to both types of passive systems; however, the present description focuses on inductively coupled systems because they are presently more common due to the fact that they have a greater effective range than capacitively coupled systems. Passive inductively coupled RFID systems can include a transponder that has a microprocessor chip encircled by, and electrically connected to, a metal coil that functions as an antenna as well as an inductance element. The metal coil receives radio frequencies from a base station and generates an electrical current that powers the microprocessor, which is programmed to retrieve stored data such as an identification number and transmit the data back to the base station.

Standard transmission frequencies have been established for RFID tags based upon their field of use. For example, 13.56 MHz is a standard radio frequency used for tracking manufactured goods, whereas 400 kHz is a standard radio frequency used for tracking salmon as they travel upstream to spawn. The standard radio frequency used for identification tags for livestock and other animals is currently 134.2 kHz. This relatively low radio frequency is advantageous because it can effectively penetrate water-containing objects such as animals.

On the other hand, the frequency does not have a high transmission rate. Therefore, current RFID systems do not work well where fast data transmission is required, such as in certain real time tracking applications of fast moving objects. More particularly, due to the inherent signal transimission delay associated with current RFID systems operated at 134.2 kHz, current systems cannot in certain circumstances effectively query and retrieve identification numbers, also commonly referred to as identification codes, from identification tags as the animals move rapidly past a particular point in space, such as when cattle move along a cattle chute commonly found at auctions or disassembly plants. Accordingly, an improved RFID system with faster data transmission capabilities is desirable.

In addition, current identification tags manufactured according to the above outlined processes are typically not customizable by the end users and generally include only a stored identification number. Hence, if the producer wishes to track other data, the data must, for example, be stored on a separate computer and electronically associated with an identification number. This limitation may necessitate carrying a computer out in the field, which can be inconvenient and impractical. In addition, once the livestock changes hands, the new livestock handler may not have access to the data that is associated with the identification number because the data is not transferred to the new handler. Instead, the data must be stored on a network or otherwise deliberately made available to the new handler. Furthermore, current identification tags are not generally adapted to be used to measure physical parameters of the animals such as the animal's internal temperature, which can be helpful in determining if the animal is ill. Accordingly, it is desirable to developed an RFID system where the livestock handler can customize the identification tag; where data in addition to an identification number can be stored in the tag itself; where the livestock handler can use the tag to track physical parameters of the livestock in real time; and/or where the system remains compatible with current base stations.

### SUMMARY OF THE INVENTION

The present invention relates to a flexible and/or implantable radio frequency identification system, such as a flexible and/or implantable radio frequency identification system for tracking animals.

In an embodiment, the present invention relates to an animal identification tag. The animal identification tag can include an RFID system, a flexible substrate, and a wrap. The tag can be configured with a rolled flexible substrate. The wrap can seal the RFID system from the surroundings.

The present invention also includes a method of manufacturing a radio frequency identification (RFID) tag, for identification of animals. The method includes providing a flexible substrate; disposing a first coil upon the substrate; coupling a first integrated circuit to the first coil; rolling the flexible substrate to produce a rolled tag; enclosing the rolled tag in a wrap, the wrap being effective for sealing the RFID system from the surroundings.

The present invention also relates to an identification tag for an animal. The tag can include an RFID system, a flexible substrate, and a wrap. The tag can be configured with a rolled flexible substrate. The wrap can seal the RFID system from the surroundings. The RFID system can include: a first circuit including a memory subunit, a power subunit, and a first transmit subunit, the subunits electrically connected to each other; a second circuit including a second transmit subunit, the second circuit electrically connected to the first circuit; an antenna connected to the first circuit. The power subunit of the first circuit can be configured to generate an electrical current when a radio signal is received by the antenna, and delivers this current to the first transmit subunit. The first transmit subunit can be configured to transmit a first signal at a first frequency when it receives electrical current from the power subunit, the first signal encoding at least a first portion of any data within the memory subunit. The second circuit can be configured to transmit a second signal at a second frequency when it when it receives electrical current from the power subunit, the second signal encoding at least a second portion of any data within the memory subunit.

### BRIEF DESCRIPTION OF THE DRAWINGS

FIG. 1 is a diagrammatic illustration of an RFID system including an embodiment of the present flexible tag.

FIG. 2 schematically illustrates an embodiment of a tag in its rolled configuration.

FIG. 3 is a diagrammatic illustration of a duel frequency RFID system according to the present invention.

FIG. 4 schematically illustrates an embodiment of a tag in its rolled configuration.

FIG. 5 is a schematic diagram of an alternative embodiment of a substrate on which identification tags according to the present invention may be formed.

FIG. 6 is a schematic diagram of an encoding device for use with the identification tags of FIG. 5.

FIG. 7 is a schematic diagram of animals tagged with an identification tag moving through a chute adjacent a transceiver.

FIG. 8 schematically illustrates a method by which an RFID tag may use the delay control value and/or repeat control value stored/encoded therein.

### DETAILED DESCRIPTION OF THE INVENTION

### DEFINITIONS

As used herein, the term “animal” refers to macroscopic animals including vertebrates. Animals include domesticated animals, such as livestock and companion animals, and wild animals, such as game animals or fish. Livestock include animals such as swine (pig), piglet, sheep, lamb, goat, bovine (e.g., cow), fish and (e.g., salmon), birds (e.g., chickens, ducks, and geese). This list of animals is intended to be illustrative only, and should not limit the scope of any of the following disclosure related to the present invention.

As used herein, the term “track” refers to the identification, location, recording, and monitoring of animals or other objects of interest, for whatever purpose or reason.

The Flexible Tag, Method, and System

A flexible and/or implantable identification tag for an animal, the tag including an antenna, a first circuit including a memory subunit, a power subunit, and a first transmit subunit, the subunits electrically connected to each other. The power subunit of the first circuit is configured to generate an electrical current when a radio signal is received by the antenna, and delivers this current to the first transmit subunit. The first transmit subunit is configured to transmit a first signal at a first frequency when it receives electrical current from the power subunit, the first signal encoding at least a first portion of any data within the memory subunit.

In an embodiment, the flexible and/or implantable tag can also include a second circuit including a second transmit subunit, the second circuit electrically connected to the first circuit, and an antenna connected to the first circuit. The second circuit is configured to transmit a second signal at a second frequency when it when it receives electrical current from the power subunit, the second signal encoding at least a second portion of any data within the memory subunit.

In an embodiment, the flexible and/or implantable animal identification tag includes a flexible substrate. A processor and an antenna can be coupled to the flexible substrate. The processor can include data memory storage, power circuitry, and transmission circuitry. The power circuitry is configured to generate electrical current when a first radio signal at a first frequency is received by the antenna. The transmission circuitry is configured to transmit at least a portion of any data within the data memory storage at a second frequency, and to transmit at least a portion of any data within the data memory storage at a second frequency when electrical current is received from the power circuitry.

In an embodiment, the antenna can be embossed or printed on the flexible substrate. The antenna can be flexible, such that the antenna remains intact when the flexible substrate is altered from a flat configuration to, for example, a rolled configuration. Suitable antenna structures include those found on anti-theft or tracking devices configured for adhering to a cover of a book, for example, a library book. The antenna can include or be composed of a conductive material, such as silver. The antenna can be configured on the flexible substrate for effective reception of electromagnetic energy of the desired frequency when the substrate is rolled up. In such a configuration, the antenna can effectively provide energy to the processor. The conductive material can be applied to the flexible substrate by, for example, lithography, “ink-jet” type printing, stamping, sputtering, or the like.

In an embodiment, the processor is sized to effectively roll up in the rolled flexible substrate. A suitable processor can have a generally square or rectangular flat solid about 3 mil on its longest side or across a diagonal. In an embodiment, a suitable processor can roll up in the rolled flexible substrate without enlarging the diameter of the rolled substrate compared to the rolled flexible substrate including the antenna but not the processor. In an embodiment, the processor is positioned on the flexible substrate to be rolled in an outer or outermost layer of the rolled substrate. In an embodiment, the processor is positioned on the flexible substrate to be rolled in an inner or innermost layer of the rolled substrate. The processor is constructed to operate in the rolled flexible substrate.

In an embodiment, the processor and antenna are coupled to the flexible substrate and sealed from the surroundings by a wrap. In an embodiment, the wrap is made from or includes a polymer, such as a biocompatible polymer. For example, the wrap be composed of a parylene. The wrap can be disposed on one or more sides of the flexible substrate. The wrap can envelope the flexible substrate. Sealed from the surroundings is means that fluids, such as biological fluids, do not penetrate the wrap and disable or shorten the life of the RFID system.

The present flexible and/or implantable animal identification tag can be configured to provide a generally cylindrical roll dimensioned to fit in the cannula of a needle or catheter. For example, the rolled system can be generally cylindrical and have a diameter allowing it to fit in a 12 gauge needle, in a 10 gauge needle, in an 8 gauge needle, or the like. For example, the rolled system can be generally cylindrical and have a diameter less than or equal to 2 mm, 1 mm, or 0.5 mm.

The present invention includes an animal, implanted in the animal is a tag according to the present invention.

Additional features of and suitable circuitry for the present rolled tag include those disclosed in U.S. patent application Ser. No. 11/282,295, filed Nov. 17, 2005, the disclosure of which is incorporated herein by reference.

### Illustrated Embodiments

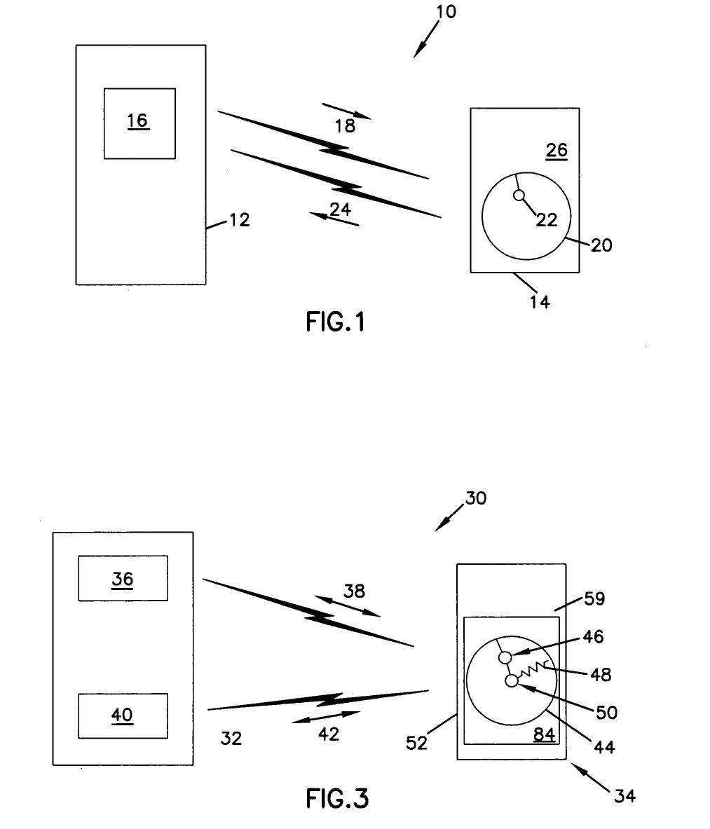

FIG. 1 schematically illustrates an embodiment of the present flexible and/or implantable animal identification tag 14 as a component of a first RFID system 10. The first RFID system 10 includes a base station 12, also commonly referred to as a reader, and an identification tag 14. In the depicted first RFID system 10, the identification tag 14 and base station 12 are configured to be used to track livestock. In an embodiment, the base station 12 and identification tag 14 are configured to transmit and receive radio waves at the current industry standard for RFID livestock tracking, which is 134.2 kHz. The base station includes a transceiver 16 that emits a radio signal 18, which may be received by the identification tag 14.

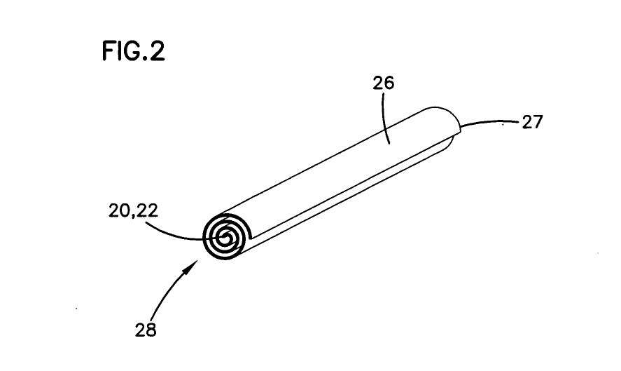

The identification tag 14 includes a wire loop antenna 20 constructed of metal. The wire loop antenna 20 receives the signal 18 and functions as an inductor to generate an electric current from the signal 18. The generated electric current powers the semiconductor chip 22, which is programmed to retrieve a stored identification number/code and convert the number into a signal 24 that is transmitted back to the transceiver 16 in the base station 12. In the embodiment shown, the identification tag 14 includes flexible substrate 26, which can be rolled to produce rolled identification tag 28 (FIG. 2).

The identification tag 14 includes seal 27 as an embodiment of the wrap. The seal isolates components (e.g., wire loop antenna 20 and chip 22) of the identification tag 14 from the surroundings. Seal 27 can be in the form of a layer of biocompatible polymer applied on and surrounding identification tag 14. Seal 27 can be composed of a polymer such as a parylene.

FIG. 2 schematically illustrates an embodiment of identification tag 14 in its rolled configuration, i.e. rolled identification tag 28.

FIG. 3 schematically illustrates another embodiment of the present flexible and/or implantable duel frequency tag 34 as a component of a second RFID system 30 according to the present invention. In the depicted embodiment the second RFID system 30 includes a base station 32 and a dual frequency tag 34. The base station 32 includes a first device 36 for transmitting and receiving signals at a first frequency 38 and a second device 40 for transmitting and receiving signals at a second frequency 42. In an embodiment, the first frequency 38 can be the standard frequency of 134.2 kHz and the second frequency 42 can be a higher frequency than the first frequency 38. The dual frequency tag 34 includes an antenna, e.g., a wire loop antenna 44, that is configured to receive and transmit on the first frequency 38.

The depicted wire loop antenna 44 is made of metal and also functions as an inductor to generate an electrical current for powering a first semiconductor chip 46. The first semiconductor chip 46 can be programmed to retrieve a stored identification number and transmit that identification number back to the first device 36 of the base station 32 over the first frequency 38. In addition, the first semiconductor device 46 can be programmed to transmit the identification number back to the second device 40 of the base station 32 over the second frequency 42 via a second antenna 48. This mechanism for transmitting back to the base station can decrease the response time of the second RFID system 30. At the same time, the second RFID system 30 can be configured to remain compatible with existing systems that operate at lower frequencies.

In the depicted embodiment, the dual frequency tag 34 further includes a second semiconductor chip 50 that is electrically connected to the first semiconductor chip 46. The second semiconductor chip 50 is shown powered by the current generated by the metal wire loop antenna 44. The second semiconductor chip 50 may be configured to transmit a signal at second frequency 42. In some embodiments, the second semiconductor chip 50 is configured so that the first semiconductor chip 46 of the second RFID system 30 is very similar or even identical to the semiconductor chip 22 of the first RFID system 10.

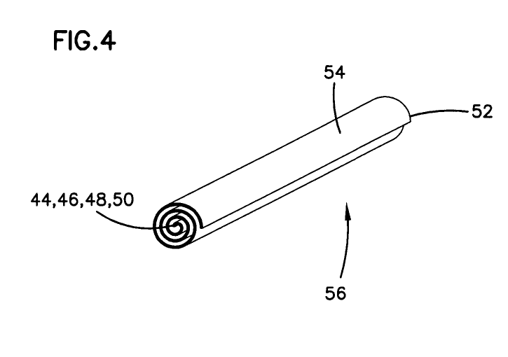

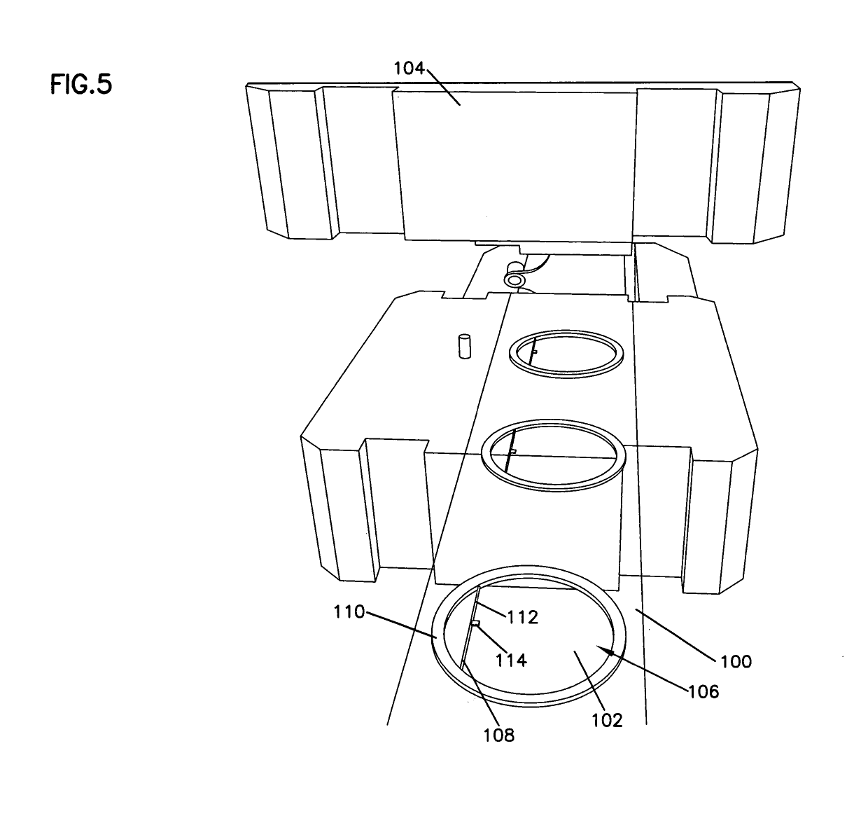

In the embodiment shown, the duel frequency tag 34 includes flexible substrate 54, which can be rolled to produce rolled duel frequency tag 56 (FIG. 4). The duel frequency tag 34 includes seal 52 as an embodiment of the wrap. The seal isolates components (e.g., antenna(s) and processor(s)) of duel frequency tag 34 from the surroundings. Seal 52 can be in the form of a layer of biocompatible polymer applied on and surrounding duel frequency tag 34. Seal 52 can be composed of a polymer such as a parylene.

FIG. 4 schematically illustrates an embodiment of duel frequency tag 34 in its rolled configuration, i.e. rolled duel frequency tag 56.

### Additional Illustrated Embodiments

Referring again to FIG. 3, in the depicted embodiment the second chip 50 may include a writeable memory device for storing customizable programmable data. Second semiconductor chip 50 can store any of a variety of data about an animal. For example, the health history, genetic characteristics, the date and location of sale, as well as other data may be stored on the second semiconductor chip 50. Alternatively, such data can be written to a data storage location of the first semiconductor chip 46. This data from the first semiconductor chip 46 can be transmitted to the base station 32 at the second higher frequency 42 via the second semiconductor chip 50. Alternatively, the customizable programmable data can be transmitted to the base station 32 at the first frequency 38 via the first semiconductor chip. The second frequency 42 can be beneficial when the medium of transfer is air, which allows for higher frequency rates and, consequently, faster rates of transfer than other materials such as water or cement.

In the various embodiments herein, the communication link(s) (e.g., communication links 38 and 42) may be conducted in either half duplex or full duplex. Thus, in the context of a half duplex embodiment, a base station, such as the base station 32 depicted in FIG. 3, may transmit a relatively low frequency carrier (e.g., 134.2 kHz) to the dual frequency tag 34, thereby transferring power to its internal circuitry. The dual frequency tag 34 is configured to receive energy during this period, but to delay its return transmission(s), until the base station 32 ceases transmission. After having transferred energy to the tag 34, the base station 32 ceases its transmission, and enters a period wherein its transceiving devices 36 and 40 attempt only reception of data. During this period, the dual frequency tag 34 may respond with one or more return transmissions. For example, the dual frequency tag 34 may simultaneously return transmission on both high and low frequency carriers 38 and 42. Alternatively, the dual frequency tag 34 may divide this period into two timeframes—a first timeframe, during which transmission on the low frequency carrier 38 is performed, and a second timeframe, during which transmission on the high frequency carrier 42 is performed. In the wake of having received a return transmission, the base station 32 may re-enter its energy transfer phase, thereby beginning the cycle anew. In contrast, in the context of a full duplex embodiment, transmissions to and from a base station, such as base station 32, and a transponder, such as dual frequency tag 34, occur simultaneously.

Full duplex schemes exhibit the quality of permitting a greater quantity of data to be communicated in a given interval of time. For this reason, under certain circumstances, full duplex embodiments may be desirable. On the other hand, half duplex systems may allow for a more reliable return communication from a transponder. In certain environments, the signal emanating from the base station may reflect off of one or more surfaces, and return to the base station. In such a circumstance, if the communication was conducted in full duplex, the base station would also be receiving a return transmission from the transponder, meaning that the reflected signal and the return transmission would interfere with one another. A half duplex system reduces such interference by delaying return transmissions until the base station is no longer transmitting (when the base station ceases transmission, it ceases to emit signals that can be reflected back to itself, causing the unwanted interference). Half duplex systems possess other advantages in terms of simplicity and cost, as well.

The ability of duel frequency tag 34 to store more data than an identification number can be beneficial because, for example, a tagged animal is often handled or processed by a number of different individuals. Ensuring that each individual has access to the data associated with the animal when the data is stored remotely from the animal can be difficult and expensive. However, when the data in the second RFID system 30 is stored on the semiconductor chip 50 that is implanted in the animal, the handler of the animal can gain access to the relevant information about the animal.

A further embodiment of an identification tag according to the present invention may include a forming or molding process involving a strip flexible substrate onto which are positioned various components of the tag. Such a strip flexible substrate 100 is shown in FIG. 5. Flexible substrate 100 includes a plurality of mounting locations 102 onto which are positioned the components of a tag in a desired order (which will be described further below). Flexible substrate 100 can be made of any of a variety of materials of sufficient strength and flexibility to provide a workable tag. It is anticipated that substrate 100 and tag 122 can include or be made of any of a wide variety of thermoactive materials. Numerous suitable thermoactive materials are commercially available.

To begin forming a tag, substrate 100 is extended into a tag production device 104, which may be a single enclosed machine or which may be composed of a plurality of individual machines performing one or more but not all of the constituent processes.

A first mounting location 102 is positioned within device 104 so one or more wires or circuits 106 may be formed onto substrate 100. Circuits 106 may include a first lead 108, a coil 110, and a second lead 112. A chip 114 may be positioned and electrically connected to leads 108 and 112. Coil 110 is preferably composed of a plurality of windings of an electrically conductive wire, and may serve as both an induction coil and a transmission antenna, as described above. A secondary antenna may also be laid onto substrate 100 at location 102, such as within coil 110 as shown in the FIGS., above. Alternatively, coil 110 may serve as both high and low frequency transmission antenna, so that secondary antenna is not needed. As a further alternative, the secondary antenna could be located outside of coil 110 and still electrically connected to chip 114.

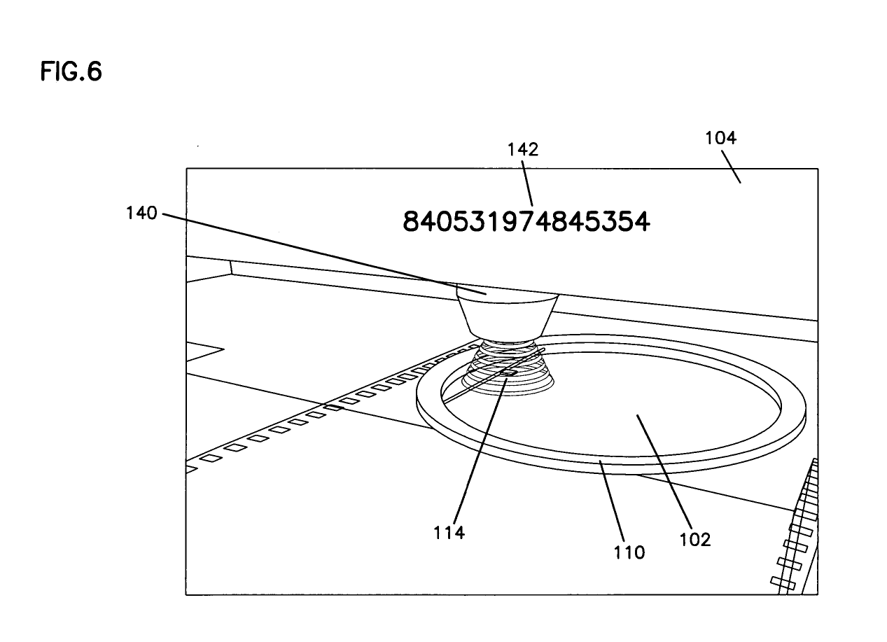

In an embodiment, once coil 110, leads 108 and 112, and chip 114 have been positioned on substrate 100 at a position 102, device 104 may include a data write head 140 to digitally encode a unique identifier 142 into chip 114, as shown in FIG. 6.

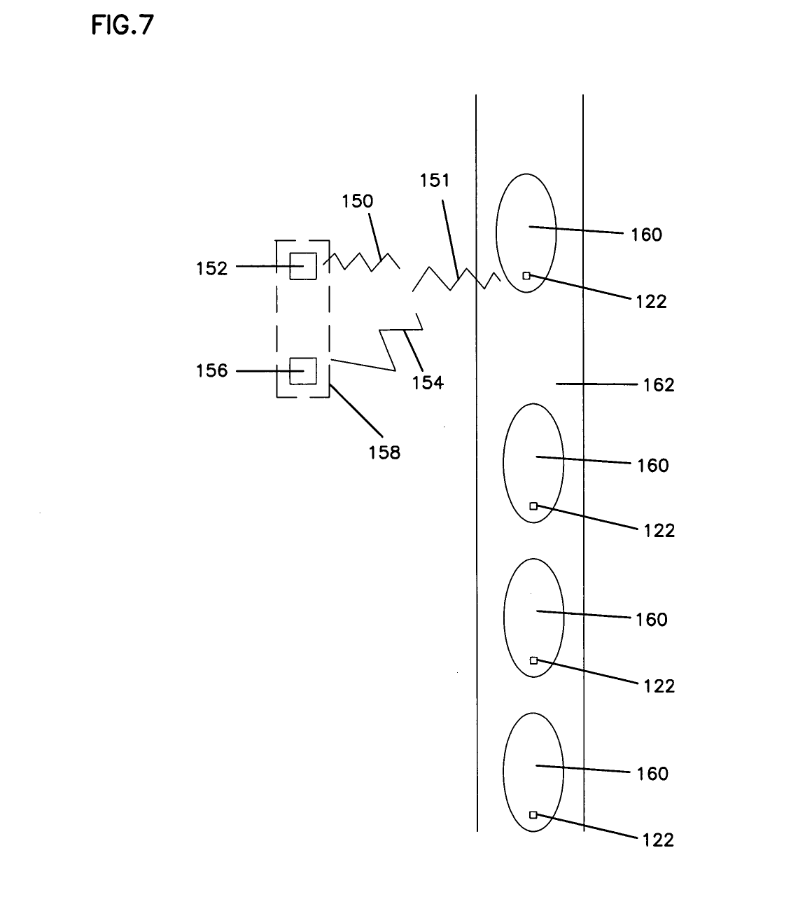

As described above, tag 122 is shown with a single chip 114 mounted to substrate 100 (FIG. 7). In this embodiment, chip 114 is capable of handling both high and low frequency transmission. It is also anticipated that two separate chips may be mounted within each tag 122. One of the chips may manage receipt of power induced by an external signal received through coil 110 and then the transmission of one of the two transmission frequencies. The first chip would also pass some of the induced energy from coil 110 to the second chip. The second chip may then transmit on the second frequency. It may be desirable to use two separate chips to reduce overall cost of production or to improve efficiency of the transmission or reception functions of tag 122. Alternatively, using two chips may enable more flexibility in the use of alternative embodiments of tags, as will be described below.

As described above, one of the unique features of tag 122 is the inclusion of two distinct transmission frequencies. In addition, these two frequencies may be provided to communicate different sets of data and they may function at different ranges or proximities to a transceiver keyed to induce power into coil 110. Differences in frequency may also be configured to provide different depths of penetration as balanced with signal or data density or transmission speed. For example, a lower frequency signal, such as query signal 150 and reply signal 151 will be able to penetrate through relatively more material but will have relatively shorter range of transmission to an external transceiver 152, as shown in FIG. 7. Such a lower frequency signal will also be able to transmit relatively less data over time. A higher frequency signal 154 will provide a greater transmission distance if the range is unobstructed, though signal 154 will be less likely to penetrate an obstruction as well as signal 150. Further, signal 154 will be able to transmit a greater amount of data over the same amount of time to a receiver 156, as compared to signal 150.

However, since there is growing acceptance of a standard, or ISO frequency for use with agricultural animals, such as cattle, at least one of the frequencies transmitted by tag 122 preferably conforms to the standard. The second, or any additional frequencies may be configured as desired by a user or producer to accomplish other herd management or sales tasks. For example, a producer may desire to have identification tags implanted in cattle which transmit a government issued identification number to a standard transceiver and also transmit more specific information such as date of birth, or more specific herd information, to specialized receiver. The government identifier is likely a required item that must be transmitted by tag 122, while the remaining data items are for specific herd or sales functions.

By having coil 110 optimized for use with a standardized ISO frequency, which is typically approximately 134.2 kHz, the induction coil can be used to provide power to both of the high and low speed transmission circuits. Current tags are generally arranged to receive a signal with coil 110 at the same frequency that they transmit through coil 110. Tag 122 is configured so that power is induced within coil 110 and energizes both transmit circuits at the same time. Thus, the higher frequency transmit capability of tag 122 does not require a separate coil 110 and the high frequency receiver receiving the higher frequency data signal from tag 122 does not require a transmitter. Alternatively, transceiver 152 may include receiver 156 within an integral housing such as housing 158, so that a single unit may receive both the low and high frequency signals 150 and 154.

As shown in FIG. 7, more than one animal 160 may be within range of either or both transceiver 152 and receiver 156 simultaneously. They may be within chute 162, a holding pen or corral, or some other enclosure. When this occurs, a plurality of tags 122 may be trying to respond to query signal 150, so that a plurality of signals 151 and 154 may be transmitted at the same time. In such a situation, some form of anti-collision mechanism is desirable to reduce conflicts or collisions among the plurality of signals 151 and 154 being transmitted by the plurality of tags 122 so that each of the signals 151 and 154 can be captured by transceiver 152. One embodiment of an anti-collision approach may be to include a switch in the higher frequency transmission portions of circuitry 106 of tags 122 and to configure a second transceiver 256 in place of receiver 156. Such a switch, preferably included on chip 114, would permit transceiver 256 to signal to each tag in turn when it has received the additional information 144 from that particular tag 122. When a tag 122 receives this acknowledgement signal from second transceiver 256, the tag 122 would cease to transmit its additional information 144. This will permit transceiver to in turn receive and acknowledge the receipt of the additional information 144 from each tag 122 in turn, until all the tags 122 within range of transceiver 256 have ceased to transmit high frequency signals.

Such anti-collision technology could also be applied to the lower frequency transmission by tags 122 but is less likely to be needed, due to the shorter range of the lower frequency transmissions. In addition, it may be desirable to ensure that tag 122 always transmits its government identifier when polled by transceiver 152.

According to yet another embodiment, a method of collision prevention for radio frequency identification (RFID) tags for identification of animals includes assigning each of a plurality of RFID tags a delay value. Each RFID tag is configured to receive a query from a base station, and to respond thereto by waiting for a duration of time corresponding to the delay value. Then, a response transmission is provided. The response transmission includes a unique identification number identifying an animal associated with the tag.

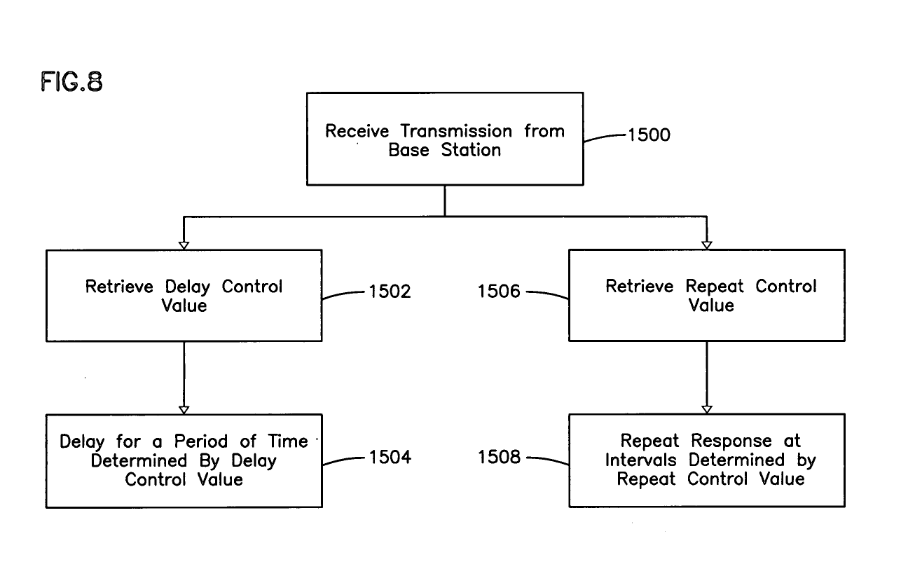

The scheme depicted in FIG. 8 operates upon the proposition that, during manufacture, or at some point thereafter, each RFID tag is encoded with either or both of a delay control value and/or a repeat control value. Briefly, a delay control value is a number store in the memory of an RFID tag, or encoded in the circuitry thereof, which determines a duration of time the RFID tag waits from the moment it receives a query to the moment it replies with a response message frame. A repeat control value is a number store in the memory of an RFID tag, or encoded in the circuitry thereof, which determines an repetition rate at which a given RFID tag sends a set of N response message frames (e.g., an RFID tag replies to a query by the transmission of N response message frames repeated at a rate determined by the repeat control value).

FIG. 8 depicts a method by which an RFID tag may use the delay control value and/or repeat control value stored/encoded therein. As can be seen from FIG. 8, a given RFID tag initially receives a query transmission, and is thereby energized (operation 1500). Next, as shown in operation 1502, the delay control value is retrieved from memory. Thereafter, the RFID tag delays for a period of time determined by the delay control value before replying with a response message frame (operation 1504). For example, the RFID tag may include a clock circuit therein (e.g., a clock circuit may be embodied within or in communication with the transmission circuitry). The delay control value may be an integer expressing the number of clock cycles to be witnessed by the transmission circuitry before replying with a response message frame. Thus, turning to FIG. 14, the RFID tag associated with animal 1410 may be assigned a delay control value causing it to delay a period of 300 ms prior to generation of a response message frame, while animal 1412 may delay for 600 ms, and animal 1414 may wait for a period of 0 ms. The net result of the delay control values, then, is to achieve a time domain multiplexing effect, in which each RFID tag within the communication zone responds at a different point in time.

An RFID tag may also respond to the receipt of a query (operation 1500) by retrieving a repeat control value stored in memory, as shown in operation 1506. Thereafter, each RFID tag may respond to the query by transmitting a set of N response message frames with a periodicity determined by the repeat control value, as depicted in operation 1508. (Again, for example, the RFID tag may include a clock circuit with, or in communication with, its transmission circuitry, in order to control the periodicity). Thus, for example, animal 1410 may be assigned a repetition rate/periodicity of 100 ms, while animal 1412 is assigned a repetition rate of 150 ms, and animal 1414 is assigned a repetition rate of 250 ms. Thus, assuming for the sake of illustration that N=3, upon receipt of the query, each RFID tag corresponding with animals 1410-1414 replies with three identical message frames. Initially, if no delay interval is used (i.e., if operations 1502-1504 are not used), each of the transmissions interferes with one another. However, during the subsequent repetitions, each RFID tag eventually transmits a response frame that is uninterrupted by the other repeated response frames, by virtue of the variety of repeat control values assigned to each tag. It is understood that the delay and repeat schemes described by operations 1502-1504 and 1506-1508 may be used individually or in combination with one another (i.e., an RFID tag may be configured to both delay its response, and to repeat its response at a desired rate).

One underlying premise of the foregoing schemes is that the delay control values and repeat control values assigned to the RFID tags associated with the incoming animals exhibit a variety sufficient to achieve the goal of providing each RFID tag with a portion of time during which it is the only RFID tag responding to the base station. To enhance the chances of that goal being realized, the delay control values and/or repeat control values assigned to the RFID tags may be stored, so that a desired distribution of delay control values and/or repeat control values may be enforced across a set of RFID tags. For example, for a given set of RFID tags, the distribution of delay control value and/or repeat control values may be approximately Gaussian or constant (i.e., “iflat”).

The flexible substrate and wrap can independently include or be composed of any of a variety of thermoactive materials. Suitable thermoactive materials include thermoplastic, thermoset material, a resin and adhesive polymer, or the like. As used herein, the term “thermoplastic” refers to a plastic that can once hardened be melted and reset. As used herein, the term “thermoset” material refers to a material (e.g., plastic) that once hardened cannot readily be melted and reset. As used herein, the phrase “resin and adhesive polymer” refers to more reactive or more highly polar polymers than thermoplastic and thermoset materials.

Suitable thermoplastics include polyamide, polyolefin (e.g., polyethylene, polypropylene, poly(ethylene-copropylene), poly(ethylene-coalphaolefin), polybutene, polyvinyl chloride, acrylate, acetate, and the like), polystyrenes (e.g., polystyrene homopolymers, polystyrene copolymers, polystyrene terpolymers, and styrene acrylonitrile (SAN) polymers), polysulfone, halogenated polymers (e.g., polyvinyl chloride, polyvinylidene chloride, polycarbonate, or the like, copolymers and mixtures of these materials, and the like. Suitable vinyl polymers include those produced by homopolymerization, copolymerization, terpolymerization, and like methods. Suitable homopolymers include polyolefins such as polyethylene, polypropylene, poly-1-butene, etc., polyvinylchloride, polyacrylate, substituted polyacrylate, polymethacrylate, polymethylmethacrylate, copolymers and mixtures of these materials, and the like. Suitable copolymers of alpha-olefins include ethylene-propylene copolymers, ethylene-hexylene copolymers, ethylene-methacrylate copolymers, ethylene-methacrylate copolymers, copolymers and mixtures of these materials, and the like. In certain embodiments, suitable thermoplastics include polypropylene (PP), polyethylene (PE), and polyvinyl chloride (PVC), copolymers and mixtures of these materials, and the like. In certain embodiments, suitable thermoplastics include polyethylene, polypropylene, polyvinyl chloride (PVC), low density polyethylene (LDPE), copoly-ethylene-vinyl acetate, copolymers and mixtures of these materials, and the like.

Suitable thermoset materials include epoxy materials, melamine materials, copolymers and mixtures of these materials, and the like. In certain embodiments, suitable thermoset materials include epoxy materials and melamine materials. In certain embodiments, suitable thermoset materials include epichlorohydrin, bisphenol A, diglycidyl ether of 1,4-butanediol, diglycidyl ether of neopentyl glycol, diglycidyl ether of cyclohexanedimethanol, aliphatic; aromatic amine hardening agents, such as triethylenetetraamine, ethylenediamine, N-cocoalkyltrimethylenediamine, isophoronediamine, diethyltoluenediamine, tris(dimethylaminomethylphenol); carboxylic acid anhydrides such as methyltetrahydrophthalic anhydride, hexahydrophthalic anhydride, maleic anhydride, polyazelaic polyanhydride and phthalic anhydride, mixtures of these materials, and the like.

Suitable resin and adhesive polymer materials include resins such as condensation polymeric materials, vinyl polymeric materials, and alloys thereof. Suitable resin and adhesive polymer materials include polyesters (e.g., polyethylene terephthalate, polybutylene terephthalate, and the like), methyl diisocyanate (urethane or MDI), organic isocyanide, aromatic isocyanide, phenolic polymers, urea based polymers, copolymers and mixtures of these materials, and the like. Suitable resin materials include acrylonitrile-butadiene-styrene (ABS), polyacetyl resins, polyacrylic resins, fluorocarbon resins, nylon, phenoxy resins, polybutylene resins, polyarylether such as polyphenylether, polyphenylsulfide materials, polycarbonate materials, chlorinated polyether resins, polyethersulfone resins, polyphenylene oxide resins, polysulfone resins, polyimide resins, thermoplastic urethane elastomers, copolymers and mixtures of these materials, and the like. In certain embodiments, suitable resin and adhesive polymer materials include polyester, methyl diisocyanate (urethane or MDI), phenolic polymers, urea based polymers, and the like.

Suitable thermoactive materials include polymers derived from renewable resources, such as polymers including polylactic acid (PLA) and a class of polymers known as polyhydroxyalkanoates (PHA). PHA polymers include polyhydroxybutyrates (PHB), polyhydroxyvalerates (PHV), and polyhydroxybutyrate-hydroxyvalerate copolymers (PHBV), polycaprolactone (PCL) (i.e. TONE), polyesteramides (i.e. BAK), a modified polyethylene terephthalate (PET) (i.e. BIOMAX), and “aliphatic-aromatic” copolymers (i.e. ECOFLEX and EASTAR BIO), mixtures of these materials and the like.

### Embodiments of the Present Tag and Method

In an embodiment, the present invention relates to an animal identification tag. The animal identification tag can include an RFID system, a flexible substrate, and a wrap. The tag can be configured with a rolled flexible substrate. The wrap can seal the RFID system from the surroundings. In an embodiment, the tag is configured for implantation in an animal. In an embodiment, the RFID system includes a processor and an antenna coupled to the flexible substrate. The antenna can be embossed or printed on the flexible substrate. The antenna can be configured on the flexible substrate for effective reception of electromagnetic energy of the desired frequency when the substrate is rolled up.

In an embodiment, the wrap can include parylene. The rolled tag can be configured to provide a generally cylindrical roll dimensioned to fit in the cannula of a needle or catheter.

In an embodiment, the tag also includes: a transponder coupled to the antenna. The transponder can include a first transmission unit, first memory and first power circuitry. The first power circuitry can be configured to receive a current induced in the first antenna, and to power the first transmission unit and first memory. The first transmission unit can be configured to retrieve data stored in the first memory and to transmit at least a portion of the data via the first antenna on a first carrier frequency and on a second carrier frequency.

In an embodiment, the transponder can include a second transmission unit, and second memory. In such an embodiment, the first power circuitry is configured to power the second transmission unit and the second memory. The first power circuitry, first transmission unit, and first memory can be embodied on a first integrated circuit, and the second transmission unit and second memory can be embodied upon a second integrated circuit. The first and second integrated circuits can be electrically coupled to one another for provision of power from the first power circuitry to the second transmission unit and second memory. In an embodiment, the tag also includes a second antenna coupled to the second transmission unit. The first transmission unit and first antenna can be configured to transmit on the first carrier frequency and the second transmission unit and second antenna can be configured to transmit on the second carrier frequency.

In an embodiment, the data stored in the memory includes a number uniquely identifying an animal. In an embodiment, upon receipt of an indication that the transmitted data was received by a base station, the transponder is configured to enter a refractory period so that the transponder does not generate a transmission until expiration of the refractory period. The transponder can be configured to pause for a delay period, prior to generating a transmission in response to a transmission from a base station.

In an embodiment, the data stored in the memory includes a number uniquely identifying an animal, and wherein the transponder is configured to generate an abbreviated number, which is the difference between the unique identifying number and another number.

The present invention also includes a method of manufacturing a radio frequency identification (RFID) tag, for identification of animals. The method includes providing a flexible substrate; disposing a first coil upon the substrate; coupling a first integrated circuit to the first coil; rolling the flexible substrate to produce a rolled tag; enclosing the rolled tag in a wrap, the wrap being effective for sealing the RFID system from the surroundings.

In an embodiment of the method, the integrated circuit includes a transmission unit, power circuitry, and a memory unit, and the method further also includes writing a number uniquely identifying an animal to the memory. In an embodiment, the method also includes accessing a data store, to determine the unique identification number, prior to writing the number to the memory. In an embodiment, the method also includes accessing a server to obtain a lot of identification numbers hitherto unassigned to other animals within a political boundary, and selecting the unique identification number for storage in the memory from said lot of unassigned numbers.

In an embodiment, the method also includes disposing a second coil upon the substrate; and coupling a second integrated circuit to the second coil. This method can also include electrically coupling the first and second integrated circuits. In an embodiment of the method, the first integrated circuit and first coil are configured to cooperate to transmit upon a first carrier frequency, and the second integrated circuit and second coil are configured to cooperate to transmit upon a second carrier frequency.

The present invention also relates to an identification tag for an animal. The tag can include an RFID system, a flexible substrate, and a wrap. The tag can be configured with a rolled flexible substrate. The wrap can seal the RFID system from the surroundings. The RFID system can include: a first circuit including a memory subunit, a power subunit, and a first transmit subunit, the subunits electrically connected to each other; a second circuit including a second transmit subunit, the second circuit electrically connected to the first circuit; an antenna connected to the first circuit. The power subunit of the first circuit can be configured to generate an electrical current when a radio signal is received by the antenna, and delivers this current to the first transmit subunit. The first transmit subunit can be configured to transmit a first signal at a first frequency when it receives electrical current from the power subunit, the first signal encoding at least a first portion of any data within the memory subunit. The second circuit can be configured to transmit a second signal at a second frequency when it when it receives electrical current from the power subunit, the second signal encoding at least a second portion of any data within the memory subunit.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the term “configured” describes a system, apparatus, or other structure that is constructed or configured to perform a particular task or adopt a particular configuration. The term “configured” can be used interchangeably with other similar phrases such as arranged and configured, constructed and arranged, adapted and configured, adapted, constructed, manufactured and arranged, and the like.

All publications and patent applications in this specification are indicative of the level of ordinary skill in the art to which this invention pertains.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. An animal identification tag comprising:
an RFID system, a flexible substrate, and a wrap;
the tag being configured with a rolled flexible substrate;
the wrap sealing the RFID system from the surroundings.

2. The tag of claim 1, wherein the tag is configured for implantation in an animal.

3. The tag of claim 1, wherein the RFID system comprises a processor and an antenna coupled to the flexible substrate.

4. The tag of claim 3, wherein the antenna can be embossed or printed on the flexible substrate.

5. The tag of claim 3, wherein the antenna is configured on the flexible substrate for effective reception of electromagnetic energy of the desired frequency when the substrate is rolled up.

6. The tag of claim 1, wherein the wrap comprises parylene.

7. The tag of claim 1, wherein the rolled tag is configured to provide a generally cylindrical roll dimensioned to fit in the cannula of a needle or catheter.

8. The tag of claim 1, further comprising:
a first antenna; and
a transponder coupled to the antenna, the transponder including a first transmission unit, first memory and first power circuitry, the first power circuitry being configured to receive a current induced in the first antenna, and to power the first transmission unit and first memory, the first transmission unit being configured to retrieve data stored in the first memory and to transmit at least a portion of the data via the first antenna on a first carrier frequency and on a second carrier frequency.

9. The tag of claim 8, wherein the transponder includes a second transmission unit, and second memory.

10. The tag of claim, wherein the first power circuitry is configured to power the second transmission unit and the second memory.

11. The tag of claim 10, wherein the first power circuitry, first transmission unit, and first memory are embodied on a first integrated circuit, and the second transmission unit and second memory are embodied upon a second integrated circuit, the first and second integrated circuits are electrically coupled to one another for provision of power from the first power circuitry to the second transmission unit and second memory.

12. The tag of claim 11, further comprising a second antenna coupled to the second transmission unit.

13. The tag of claim 12, wherein the first transmission unit and first antenna are configured to transmit on the first carrier frequency, and the second transmission unit and second antenna are configured to transmit on the second carrier frequency.

14. The tag of claim 8, wherein the data stored in the memory includes a number uniquely identifying an animal.

15. The tag of claim 8, wherein, upon receipt of an indication that the transmitted data was received by a base station, the transponder is configured to enter a refractory period so that the transponder does not generate a transmission until expiration of the refractory period.

16. The tag of claim 8, wherein the transponder is configured to pause for a delay period, prior to generating a transmission in response to a transmission from a base station.

17. The tag of claim 8, wherein the data stored in the memory includes a number uniquely identifying an animal, and wherein the transponder is configured to generate an abbreviated number, which is the difference between the unique identifying number and another number.

18. A method of manufacturing a radio frequency identification (RFID) tag, for identification of animals, the method comprising:
providing a flexible substrate;
disposing a first coil upon the substrate;
coupling a first integrated circuit to the first coil;
rolling the flexible substrate to produce a rolled tag;
enclosing the rolled tag in a wrap, the wrap being effective for sealing the RFID system from the surroundings.

19. The method of claim 18, wherein the integrated circuit comprises a transmission unit, power circuitry, and a memory unit, and wherein the method further comprises writing a number uniquely identifying an animal to the memory.

20. The method of claim 18, further comprising accessing a data store, to determine the unique identification number, prior to writing the number to the memory.

21. The method of claim 18, further comprising accessing a server to obtain a lot of identification numbers hitherto unassigned to other animals within a political boundary, and selecting the unique identification number for storage in the memory from said lot of unassigned numbers.

22. The method of claim 18, further comprising:
disposing a second coil upon the substrate;
coupling a second integrated circuit to the second coil.

23. The method of claim 22, further comprising electrically coupling the first and second integrated circuits.

24. The method of claim 22, wherein the first integrated circuit and first coil are configured to cooperate to transmit upon a first carrier frequency, and the second integrated circuit and second coil are configured to cooperate to transmit upon a second carrier frequency.

25. An identification tag for an animal, the tag comprising:
an RFID system, a flexible substrate, and a wrap;
the tag being configured with a rolled flexible substrate;
the wrap sealing the RFID system from the surroundings;
the RFID system comprising:
a first circuit including a memory subunit, a power subunit, and a first transmit subunit, the subunits electrically connected to each other;
a second circuit including a second transmit subunit, the second circuit electrically connected to the first circuit;
an antenna connected to the first circuit;
the power subunit of the first circuit configured to generate an electrical current when a radio signal is received by the antenna, and delivers this current to the first transmit subunit;
the first transmit subunit configured to transmit a first signal at a first frequency when it receives electrical current from the power subunit, the first signal encoding at least a first portion of any data within the memory subunit;
the second circuit configured to transmit a second signal at a second frequency when it when it receives electrical current from the power subunit, the second signal encoding at least a second portion of any data within the memory subunit.
